(19) United States
(12) Patent Application Publication
(10) Pub. No.: US 2020/0272007 A1
(43) Pub. Date: Aug. 27, 2020

(54) DISPLAY PANEL REPAIR METHOD AND DISPLAY PANEL

(71) Applicant: HKC CORPORATION LIMITED, Shenzhen (CN)

(72) Inventor: Chunhui YANG, Chongqing (CN)

(21) Appl. No.: 16/349,613

(22) PCT Filed: Jan. 29, 2019
(86) PCT No.: PCT/CN2019/073641

§ 371 Date: May 14, 2019

(30) Foreign Application Priority Data
Dec. 12, 2018 (CN) 201811515458.5
Dec. 12, 2018 (CN) 201822088512.4

(51) Int. Cl. G02F 1/1362; G02F 1/1345

(52) U.S. Cl. CPC G02F 1/136286; G02F 1/13454; G02F 2001/136272; G02F 1/136259; G02F 2201/506; G02F 1/13458

(57) ABSTRACT

This application discloses a display panel repair method and a display panel. The display panel formed with an active area and a peripheral area includes: a first substrate; and a second substrate cell-assembled with the first substrate; the peripheral area includes a fan-out area; the fan-out area is located between an edge of the second substrate and an edge of the active area; the first substrate is provided with fan-out wirings for connecting the active area and the peripheral area in the fan-out area, and the number of the fan-out wirings is multiple; the first substrate is further provided with a plurality of auxiliary lines, and the auxiliary lines are arranged in one-to-one correspondence with the fan-out wirings; and at least one of the auxiliary lines is disconnected from one end of the corresponding fan-out wiring.

This application claims the priority to the Chinese Patent Application No. CN 201811515458.5, filed with National Intellectual Property Administration, PRC on Dec. 12, 2018 and entitled “DISPLAY PANEL REPAIR METHOD AND DISPLAY PANEL”, and is also an application claims the priority to the Chinese Patent Application No. CN201822088512.4, PRC on Dec. 12, 2018 and entitled “DISPLAY PANEL AND DISPLAY APPARATUS”, which are incorporated herein by reference in its entirety.

### TECHNICAL FIELD

This application relates to the field of display technologies, and in particular to a display panel repair method and a display panel.

### BACKGROUND

The description herein provides only background information related to this application, but does not necessarily constitute the existing technology.

With the development and advancement of technology, flat panel displays have become the mainstream products of displays due to their thin body, low power consumption and low radiation, and have been widely used. Flat panel displays include a thin film transistor-liquid crystal display (TFT-LCD). The TFT-LCD product is made larger and larger in size and more and more widely used due to their advantages of thinness, environmental protection and high performance. Whether it's a small-sized mobile phone screen, a large-sized notebook computer or monitor, or a large LCD TV, TFT-LCD applications can be found everywhere.

The TFT-LCD display panel includes the following processes: an array process, a color film process, a cell process, a module process, and the like. Among them, the array process is to form all circuit wirings including the active area (AA) and the peripheral area. The wiring of the fan-out area of the peripheral area is prone to open circuit or short circuit during the manufacture procedure or under other conditions, which seriously affects the yield of the display panel.

### SUMMARY

To achieve the above objective, this application provides a display panel repair method capable of repairing an open-circuited or short-circuited fan-out wiring and increasing the display panel yield and a display panel.

This application discloses a display panel formed with an active area and a peripheral area, comprising: a first substrate; and a second substrate cell-assembled with the first substrate; wherein the peripheral area comprises a fan-out area, and the fan-out area is located between an edge of the second substrate and an edge of the active area; the first substrate is provided with fan-out wirings for connecting the active area and the peripheral area in the fan-out area, the number of the fan-out wirings is multiple, the first substrate is further provided with a plurality of auxiliary lines, and the auxiliary lines are arranged in one-to-one correspondence with the fan-out wirings; and at least one of the auxiliary lines is disconnected from one end of the corresponding fan-out wiring.

Optionally, each of the auxiliary lines comprises at least one opening portion protruding outward, and the auxiliary line at the opening portion does not overlap with the corresponding fan-out wiring.

Optionally, the auxiliary line other than the opening portion overlaps with the fan-out wiring, the distance between the auxiliary line at the opening portion and the corresponding fan-out wiring is greater than zero, and the length of the opening portion corresponding to the fan-out wiring direction is greater than zero.

Optionally, each of the auxiliary lines comprises two opening portions respectively located at two ends of the auxiliary line.

Optionally, each of the auxiliary lines comprises only one opening portion located at one end of the auxiliary line or located at a position away from the two ends of the auxiliary line.

Optionally, the peripheral area further comprises a binding area, the binding area is located between an edge of the first substrate and an edge of the second substrate, and the first substrate is provided with a plurality of metal pads in the binding area; the active area comprises a plurality of pixels; the fan-out wiring comprises a first initiating terminal and a first destination terminal, the first initiating terminal and the first destination terminal are respectively located at two ends of the fan-out wiring, the first initiating terminal is located at the edge of the second substrate and connected in one-to-one correspondence with the metal pad, and the first destination terminal is located at an edge of the active area and correspondingly connected with the pixel of the active area in a control manner, and the auxiliary line comprises a second initiating terminal and a second destination terminal, the second initiating terminal and the second destination terminal are respectively located at the two ends of the auxiliary line, the second initiating terminal is adjacent to the edge of the second substrate, the second destination terminal is adjacent to the edge of the active area, and at least one of the second initiating terminal and the metal pad, and the second destination terminal and the first destination terminal of the fan-out wiring are physically disconnected.

Optionally, the fan-out wiring is provided with an insulating layer, the auxiliary line is arranged on the insulating layer, and the fan-out wiring is not connected with the auxiliary line.

Optionally, the fan-out wiring is provided with an insulating layer, the auxiliary line is arranged on the insulating layer, the second initiating terminal of the auxiliary line is connected with the first initiating terminal of the fan-out wiring, and the second destination terminal of the auxiliary line is disconnected from the first destination terminal of the fan-out wiring.

Optionally, the fan-out wiring is provided with an insulating layer, the auxiliary line is arranged on the insulating layer, the second initiating terminal of the auxiliary line is disconnected from the first initiating terminal of the fan-out wiring, and the second destination terminal of the auxiliary line is connected with the first destination terminal of the fan-out wiring.

Optionally, the fan-out wiring is provided with an insulating layer, the auxiliary line is arranged on the insulating layer, the auxiliary line and the corresponding fan-out wiring have the same shape, and the auxiliary line correspondingly overlaps with the fan-out wiring.

Optionally, the line width of the auxiliary line is the same as the line width of the fan-out wiring.

Optionally, the thickness of the auxiliary line is the same as the thickness of the fan-out wiring.

Optionally, the distance between the auxiliary line at the opening portion and the corresponding fan-out wiring is greater than zero.

Optionally, the length of the opening portion along the fan-out wiring direction is greater than the width of the fan-out wiring.

This application further discloses a display panel formed with an active area and a peripheral area, comprising: a first substrate; and a second substrate cell-assembled with the first substrate; wherein the peripheral area comprises a fan-out area, and the fan-out area is located between an edge of the second substrate and an edge of the active area; the first substrate is provided with fan-out wirings for connecting the active area and the peripheral area in the fan-out area, the number of the fan-out wirings is multiple, the first substrate is further provided with a plurality of auxiliary lines, and the auxiliary lines are arranged in one-to-one correspondence with the fan-out wirings; each of the auxiliary lines comprises at least one opening portion protruding outward, the auxiliary line at the opening portion does not overlap with the corresponding fan-out wiring, and two ends of at least one of the auxiliary lines are respectively conducted with the two ends of the corresponding fan-out wiring.

This application further discloses a display panel repair method, wherein the display panel comprises: a first substrate; and a second substrate cell-assembled with the first substrate; wherein a peripheral area comprises a fan-out area, and the fan-out area is located between an edge of the second substrate and an edge of an active area; the first substrate is provided with fan-out wirings for connecting the active area and the peripheral area in the fan-out area, the number of the fan-out wirings is multiple, the first substrate is further provided with a plurality of auxiliary lines, and the auxiliary lines are arranged in one-to-one correspondence with the fan-out wirings; and each of the auxiliary lines comprises at least one opening portion protruding outward, the auxiliary line at the opening portion does not overlap with the corresponding fan-out wiring, and at least one of the auxiliary lines is disconnected from one end of the corresponding fan-out wiring.

The display panel repair method comprises steps of:

detecting whether the fan-out wirings are normal;
when at least one of the fan-out wirings is open-circuited, respectively connecting a second initiating terminal and a second destination terminal of the auxiliary line with a first initiating terminal and a first destination terminal of the corresponding fan-out wiring; and
when at least two of the fan-out wirings are short-circuited, disconnecting the fan-out wiring corresponding to the opening portion of the auxiliary line, and respectively connecting the second initiating terminal and the second destination terminal of the auxiliary line with the first initiating terminal and the first destination terminal of the fan-out wiring.

Optionally, the second initiating terminal of the auxiliary line is connected with the first initiating terminal of the fan-out wiring, and the second destination terminal of the auxiliary line is connected with the first destination terminal of the fan-out wiring through laser melting.

Optionally, the fan-out wiring corresponding to the opening portion of the auxiliary line is disconnected by laser disconnection at the opening portion.

Optionally, the second initiating terminal of the auxiliary line is connected with the first initiating terminal of the fan-out wiring through a via hole.

Optionally, the second destination terminal of the auxiliary line is connected with the first destination terminal of the fan-out wiring through a via hole.

The fan-out wiring is routed in the fan-out area at a fixed position and a fixed distance, and the resistance value is required to be as small as possible, so that the fan-out wirings have the characteristics of long and thin lines and small distance between adjacent fan-out wirings, that is, the fan-out wirings are prone to be open-circuited or short-circuited due to the manufacture procedure or other reasons. In this application, an auxiliary line is arranged at a position corresponding to each of the fan-out wirings, each of the auxiliary lines comprises at least one opening portion protruding outward, and the auxiliary line is not connected with the fan-out wiring and is used as a backup line, so that the open-circuited fan out wiring can be repaired and the short-circuited fan-out wiring can also be repaired. When the fan-out wiring is open-circuited, the two ends of the open-circuited fan-out wiring are connected with the two ends of the corresponding auxiliary line; and when the fan-out wiring is short-circuited, the fan-out wiring of the opening portion of the corresponding auxiliary line is disconnected, and the two ends of the auxiliary line are connected with the two ends of the corresponding fan-out wiring, so that signals originally transmitted through the open-circuited or short-circuited fan-out wiring can be transmitted through the auxiliary line, thereby preventing the display panel from incapability of working normally due to the open circuit or short circuit of the fan-out wiring, and increasing the yield of the display panel.

### BRIEF DESCRIPTION OF DRAWINGS

The accompanying drawings included are used for helping understand the embodiments of this application, constitute a part of this specification, illustrate examples of the embodiments of this application and, together with the description, serve to explain the principles of this application. Apparently, the accompanying drawings in the following description merely show some embodiments of this application, and persons of ordinary skill in the art may still derive other drawings from these accompanying drawings without creative effort. In the figures:

FIG. 1 is a schematic view of a display panel according to an embodiment of this application.

FIG. 2 is a schematic view of a fan-out area and a binding area according to an embodiment of this application.

FIG. 3 is a schematic view of a fan-out wiring according to an embodiment of this application.

FIG. 4 is a schematic view of an auxiliary line according to an embodiment of this application.

FIG. 5 is a schematic view of an auxiliary line and a fan-out wiring according to an embodiment of this application.

FIG. 6 is a schematic view of a section A-A′ of FIG. 5.

FIG. 7 is a schematic view of another fan-out wiring according to an embodiment of this application.

FIG. 8 is a schematic view of another auxiliary line according to an embodiment of this application.

FIG. 9 is a schematic view of another auxiliary line according to an embodiment of this application.

FIG. 10 is a schematic view of another auxiliary line according to an embodiment of this application.

FIG. 11 is a top view of a metal pad according to an embodiment of this application.

FIG. 12 is a schematic view of a section B-B′ of FIG. 12.

FIG. 13 is a schematic flow chart of a display panel repair method according to an embodiment of this application.

FIG. 14 is a schematic view of the auxiliary line after repairing according to an embodiment of this application.

FIG. 15 is a schematic view of a section C-C′ of FIG. 14.

FIG. 16 is a schematic view of another fan-out wiring and auxiliary line according to an embodiment of this application.

FIG. 17 is a schematic view of a display device according to an embodiment of this application.

### DETAILED DESCRIPTION

It should be understood that the terms used herein, specific structures and functional details disclosed herein are merely representative, and are intended to describe specific embodiments. However, this application may be specifically implemented in many alternative forms, and should not be construed as being limited to the embodiments set forth herein.

In the description of this application, the terms such as “first” and “second” are used only for the purpose of description, and should not be understood as indicating the relative importance or implicitly specifying the number of the indicated technical features. Therefore, unless otherwise stated, a feature defined by “first” or “second” can explicitly or implicitly include one or more of said features, and “a plurality of” means two or more than two. The terms “include”, “comprise” and any variant thereof are intended to cover non-exclusive inclusion, and do not preclude the presence or addition of one or more other features, integers, steps, operations, elements, components, and/or combinations thereof.

In addition, orientation or position relationships indicated by the terms such as “center”, “transverse”, “on”. “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating that the mentioned apparatus or component must have a particular orientation or must be constructed and operated in a particular orientation. Therefore, such terms should not be construed as limiting of this application.

In addition, unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. Persons of ordinary skill in the art may understand the specific meanings of the foregoing terms in this application according to specific situations.

This application is further described below with reference to the accompanying drawings and embodiments.

The array process of a thin film transistor-liquid crystal display panel is to form all circuit wirings including an active area (AA) and a non-active area. A complete display panel can be divided into: an active area, a binding area (between the edge of a color film substrate and the edge of an array substrate), a fan-out area (between the edge of the color film substrate and the edge of the active area) and a driver chip (gate chip on film, source chip on film, printed circuit board). Taking the line on the side of the source chip on film as an example, in order to provide an external data signal to the AA area, i.e., to bind the signal of the chip on film to the metal pad through an anisotropic conductive adhesive, and fan-out wirings are formed in the fan-out area, that is, the fan-out area is a bridge connecting the line of the AA area with the signal of the metal pad of the binding area. The fan-out wiring is routed at a fixed position and at a fixed distance, and the resistance value is required to be as small as possible, so that the fan-out wirings have the characteristics of long and thin lines and small distance between adjacent fan-out wirings, that is, the fan-out wirings are prone to be open-circuited or short-circuited due to a certain reason of the manufacture procedure.

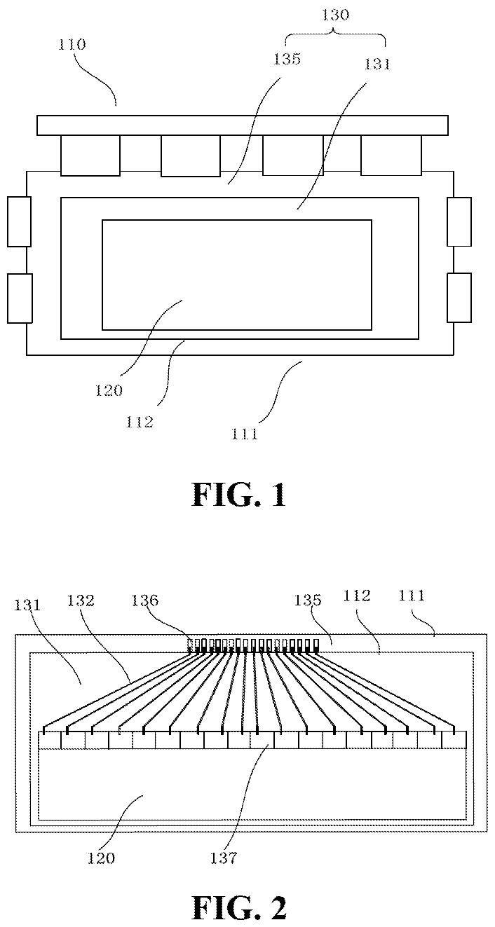

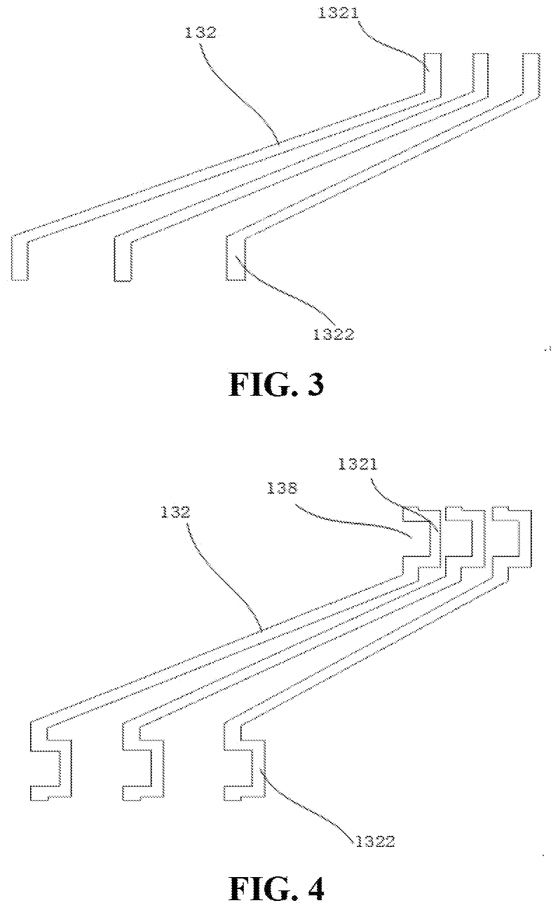

As shown in FIG. 1 to FIG. 7, an embodiment of this application discloses a display panel 110 formed with an active area 120 and a peripheral area 130, including: a first substrate 111; and a second substrate 112 cell-assembled with the first substrate 111; the peripheral area 130 includes a fan-out area 131, and the fan-out area 131 is located between an edge of the second substrate 112 and an edge of the active area 120; the first substrate 111 is provided with fan-out wirings 132 for connecting the active area 120 and the peripheral area 130 in the fan-out area 131, the number of the fan-out wirings 132 is multiple, the first substrate 111 is further provided with a plurality of auxiliary lines 133, and the auxiliary lines 133 are arranged in one-to-one correspondence with the fan-out wirings 132; and at least one of the auxiliary lines 133 is disconnected from one end of the corresponding fan-out wiring 132.

The fan-out wiring 132 is routed in the fan-out area 131 at a fixed position and a fixed distance, and the resistance value is required to be as small as possible, so that the fan-out wirings 132 have the characteristics of long and thin lines and small distance between adjacent fan-out wirings 132, that is, the fan-out wirings 132 are prone to be open-circuited due to the manufacture procedure or other reasons. In this application, an auxiliary line 133 is arranged at a position corresponding to the fan-out wiring 132, and the auxiliary line 133 that is originally not connected with the fan-out wiring 132 is used as a backup line, so that the open-circuited fan-out wiring 132 can be repaired. When the fan-out wiring 132 is open-circuited, the two ends of the open-circuited fan-out wiring 132 are connected with the two ends of the corresponding auxiliary line 133, so that signals originally transmitted through the open-circuited fan-out 132 wiring can be transmitted through the auxiliary line 133, thereby preventing the display panel 110 from incapability of working normally due to the open circuit of the fan-out wiring 132, and the display panel 110 that should be scrapped can be used normally, thereby increasing the yield of the display panel 110.

In one or more embodiments, each of the auxiliary lines 133 includes at least one opening portion 138 protruding outward, and the auxiliary line 133 at the opening portion 138 does not overlap with the corresponding fan-out wiring 132. Certainly, the shape of the opening portion 138 is not limited to a square shape, and may be a curved shape or other operable shapes.

In this solution, an auxiliary line 133 is arranged at a position corresponding to each of the fan-out wirings 132, each of the auxiliary lines 133 includes at least one opening portion 138 protruding outward, and the auxiliary line 133 that is originally not connected with the fan-out wiring 132 is used as a backup line, so that the open-circuited fan-out wiring 132 can be repaired and the short-circuited fan-out wiring 132 can also be repaired. The two ends of the open-circuited fan-out wiring 132 are connected with the two ends of the corresponding auxiliary line 133, so that signals originally transmitted through the open-circuited fan-out wiring 132 can be transmitted through the auxiliary line 133; and the two ends of the short-circuited fan-out wiring 132 are connected with the two ends of the auxiliary line 133, and the fan-out wiring 132 of the opening portion 138 is disconnected, so that signals originally transmitted through the short-circuited fan-out wiring 132 can be transmitted through the auxiliary line 133, thereby preventing the display panel 110 from incapability of working normally due to the open circuit or short circuit of the fan-out wiring 132, and increasing the yield of the display panel 110.

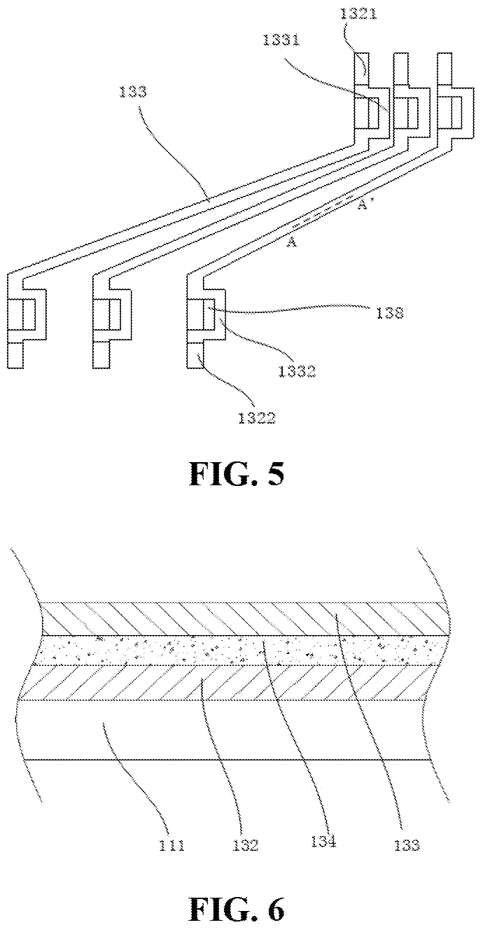

In one or more embodiments, as shown in FIG. 5, the auxiliary line 133 other than the opening portion 138 overlaps with the fan-out wiring 132, the distance between the auxiliary line 133 at the opening portion 138 and the corresponding fan-out wiring 132 is greater than zero, and the length of the auxiliary line 133 at the opening portion 138 in the same direction as the corresponding fan-out wiring 132 is greater than the line width of the auxiliary line 133. The auxiliary line 133 and the fan-out wiring 132 have the same line width, and thus, can share a portion of a mask in the manufacture procedure; and the auxiliary line 133 other than the opening portion 138 overlaps with the fan-out wiring 132, thereby facilitating the regular routing of the fan-out area 131 and also facilitating the connection operation on the two ends of the auxiliary line 133 and the two ends of the fan-out wiring 132 when the fan-out wiring 132 is open-circuited. In addition, the length d5 of the opening portion 138 along the corresponding fan-out wiring direction is greater than zero, and certainly, the d5 may also be greater than the minimum precision of the laser cutting; or the d5 may also be set to be greater than the line width of the fan-out wiring to ensure no sticking portion after the cutting, and an operating space may be reserved when the fan-out wiring 132 is short-circuited, so as to effectively carry out the disconnection operation on the fan-out wiring 132 at the opening portion 138.

In one or more embodiments, as shown in FIG. 4, each of the auxiliary lines 133 includes two opening portions 138 respectively located at two ends of the auxiliary line 133. The two ends of the auxiliary line 133 are both provided with the opening portion 138; and when the adjacent fan-out wirings 132 are short-circuited, the disconnection operation of the short-circuited fan-out wiring 132 may be carried out on the opening portion 138 at any end of the two ends, or the fan-out wirings 132 corresponding to the opening portions 138 at the two ends may be both disconnected.

In one or more embodiments, as shown in FIG. 2, the peripheral area 130 further includes a binding area 135, the binding area 135 is located between an edge of the first substrate 111 and an edge of the second substrate 112, and the first substrate 111 is provided with a plurality of metal pads 136 in the binding area 135; the active area 120 includes a plurality of pixels 137; the fan-out wiring 132 includes a first initiating terminal 1321 and a first destination terminal 1322, the first initiating terminal 1321 and the first destination terminal 1322 are respectively located at two ends of the fan-out wiring 132, the first initiating terminal 1321 is located at the edge of the second substrate 112 and connected in one-to-one correspondence with the metal pad 136, and the first destination terminal 1322 is located at an edge of the active area 120 and correspondingly connected with the pixel 137 in a control manner; and the auxiliary line 133 includes a second initiating terminal 1331 and a second destination terminal 1332, the second initiating terminal 1331 and the second destination terminal 1332 are respectively located at the two ends of the auxiliary line 133, the second initiating terminal 1331 is adjacent to the edge of the second substrate 112, the second destination terminal 1332 is adjacent to the edge of the active area 120, and at least one of the second initiating terminal 1331 and the metal pad 136, and the second destination terminal 1332 and the first destination terminal 1322 of the fan-out wiring 132 are physically disconnected.

The fan-out wiring 132 functions to transmit a signal between the metal pad 136 of the binding area 135 and the pixel 137 of the active area 120; and therefore, the first initiating terminal 1321 of the fan-out wiring 132 is connected in one-to-one correspondence with the metal pad 136, the first destination terminal 1322 is correspondingly connected with the pixel 137 in a control manner, and the auxiliary line 133 as a backup line does not need to be connected with the metal pad 136 and the pixel 137 and is in an open-circuited state at one end or a disconnected state at the two ends. Only when the fan-out wiring 132 is open-circuited and cannot transmit the signals, the two ends of the auxiliary line 133 need to be connected with the metal pad 136 and the corresponding pixel 137, that is, the two ends of the auxiliary line 133 are connected with the two ends of the corresponding open-circuited fan-out wiring 132.

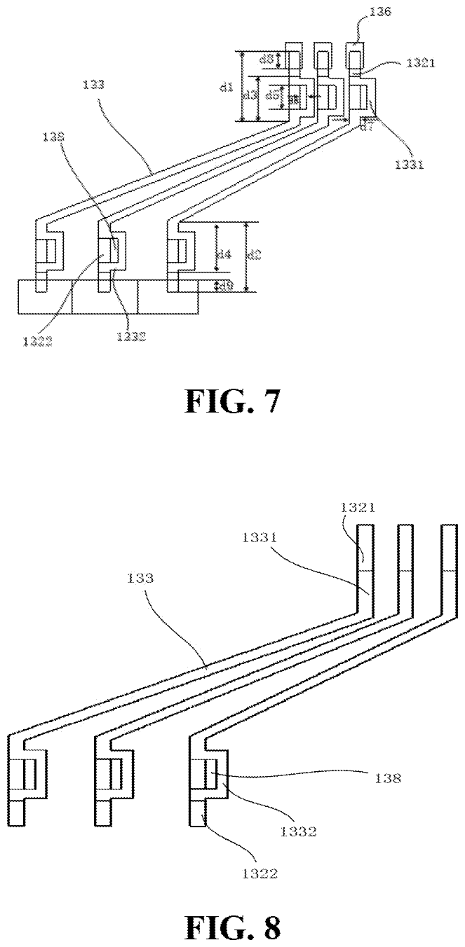

Specifically, as shown in FIG. 7, the first initiating terminal and the metal pad 136 can be connected by overlapping one section, and the second destination terminal 1332 and the pixel 137 can be connected by overlapping one section; and the length of the first initiating terminal is d1, the length of the first destination terminal 1322 is d2, the length of the second initiating terminal is d3, the length of the second destination terminal 1332 is d4, the height of the opening portion 138 or the length of the opening portion along the fan-out wiring direction is d5, the distance between the auxiliary line 133 at the opening portion 138 and the fan-out wiring 132 is d6, the line width of the auxiliary line 133 and the fan-out wiring 132 is d7, the length of the overlap between the first initiating terminal and the metal pad 136 is d8, and the width of the overlap between the second destination terminal 1332 and the pixel 137 is d9. Where d5>0 or d5>d7, that is, the length of the opening portion along the fan-out wiring direction is greater than the width of the fan-out wiring, d6>0, and a repair space can be reserved for the short-circuited fan-out wiring 132; d8>0, d1−d8>0, and 0<d3<d1−d8, thereby preventing the second initiating terminal from being connected with the metal pad 136; d9>0, d2−d9>0, and 0<d4<d2−d9, thereby preventing the second destination terminal 1332 from being connected with the pixel 137.

The fan-out wiring 132 is provided with an insulating layer 134, the auxiliary line 133 is arranged on the insulating layer 134, and the fan-out wiring 132 is not connected with the auxiliary line 133. If the auxiliary line 133 as a backup line is connected with the fan-out wiring 132, when the fan-out wiring 132 is short-circuited, the auxiliary line 133 cannot perform a repair function.

In one or more embodiments, the auxiliary line 133 and the fan-out wiring 132 have the same shape and the same line width. The auxiliary line 133 has the same shape and line width as the fan-out wiring 132, so that the routing layout of the fan-out area 131 can be regular, and it is also possible to avoid the problems of difficulty in routing and high proneness to short-circuiting of the fan-out area 131 due to a large number of fan-out wirings 132 and a too small distance between the adjacent fan-out wirings 132. Certainly, as shown in FIG. 7, the shape of the auxiliary line 133 may also be not completely the same as that of the fan-out wiring 132, each of the two ends of the auxiliary line 133 may be provided with an opening portion 138 protruding toward the side edge, and the auxiliary line 133 at the opening portion 138 does not overlap with the corresponding fan-out wiring 132.

In one or more embodiments, the thickness of the auxiliary line is the same as the thickness of the fan-out wiring. The auxiliary line has the same thickness as the fan-out wiring, so that the routing layout of the fan-out area is regular, and it is also possible to avoid the problems of difficulty in routing and high proneness to short-circuiting of the fan-out area due to a large number of fan-out wirings and a too small distance between the adjacent fan-out wirings. The auxiliary line has the same thickness as the fan-out wiring, so that the surface is regular, and the height is the same; and thus, the display panel is kept flat on the surface in each step during subsequent processing.

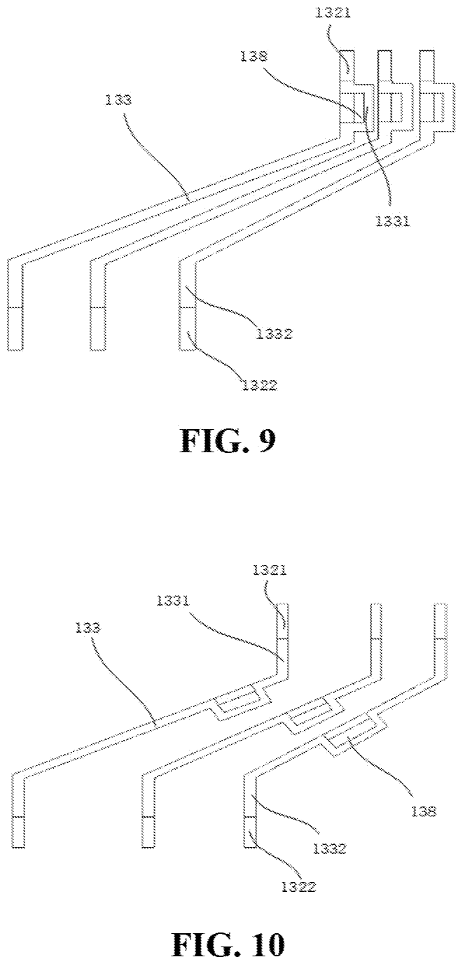

As another embodiment of this application, as shown in FIG. 8 to FIG. 10, the difference from the above embodiment is that each of the auxiliary lines 133 only includes one opening portion 138 located at one end of the auxiliary line 133 or located at a position away from the two ends of the auxiliary line 133. The auxiliary line 133 only includes one opening portion 138; no matter the opening portion 138 is located at one end of the auxiliary line 133 or at a position away from the two ends, the short-circuited fan-out wiring 132 can be disconnected when the fan-out wiring 132 is short-circuited, and the connection between the two ends of the auxiliary line 133 and the two ends of the corresponding fan-out wiring 132 is not affected. Certainly, the auxiliary line 133 may also not be provided with an opening portion 138, and at this time, the auxiliary line 133 can only implement the repair on the open-circuited fan-out wiring 132.

As another embodiment of this application, the difference from the above embodiment is that the fan-out wiring 132 is provided with an insulating layer 134, the auxiliary line 133 is arranged on the insulating layer 134, the second initiating terminal 1331 of the auxiliary line 133 is connected with the first initiating terminal 1321 of the fan-out wiring 132, and the second destination terminal 1332 of the auxiliary line 133 is disconnected from the first destination terminal 1322 of the fan-out wiring 132; alternatively, the second initiating terminal 1331 of the auxiliary line 133 is disconnected from the first initiating terminal 1321 of the fan-out wiring 132, and the second destination terminal 1332 of the auxiliary line 133 is connected with the first destination terminal 1322 of the fan-out wiring 132.

The auxiliary line 133 is used as a backup line, one end of the auxiliary line 133 is connected with the corresponding fan-out wiring 132, and the other end is disconnected from the corresponding fan-out wiring 132. When the fan-out wiring 132 is open-circuited or short-circuited and cannot transmit signals normally, it is only required to connect the open end of the auxiliary line 133 with the corresponding fan-out wiring 132 so as to connect the two ends of the auxiliary line 133 with the metal pad 136 and the corresponding pixel 137, and it is not required to carry out a repair operation on the two ends of the auxiliary line and only required to correspondingly carry out a repair operation on the open end of the auxiliary line with the fan-out wiring to achieve connection after the fan-out wiring 132 of the opening portion 138 is disconnected. Such a design not only saves the repair operation time, that is, improves the work efficiency, but also avoids the false operation that may be caused by the repair operation on the two ends, thereby increasing the repair success rate, and ensuring the normal working of the display panel 110.

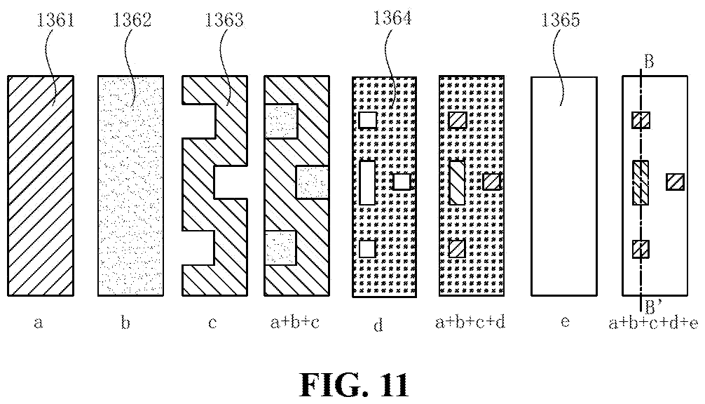

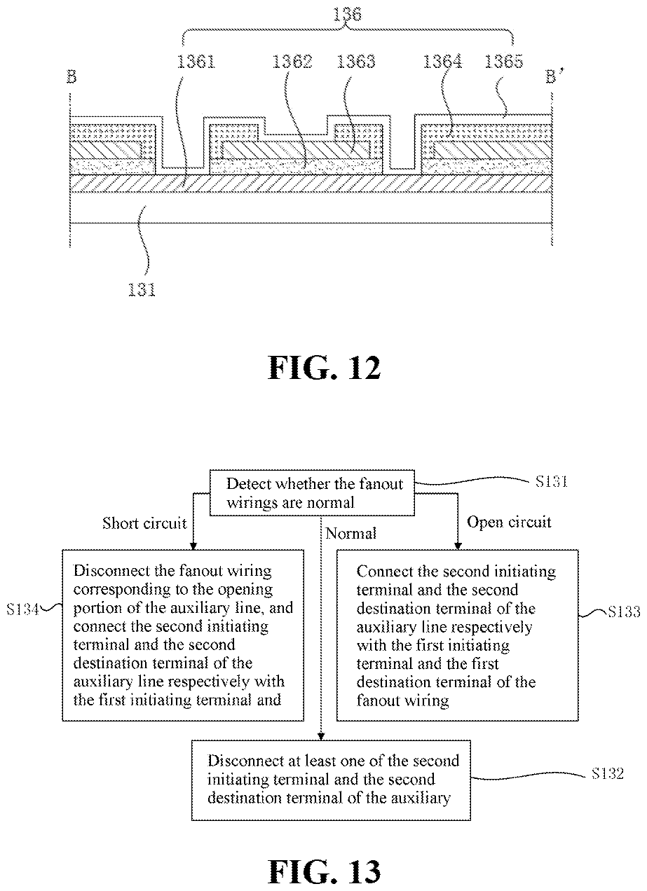

Specifically, as shown in FIG. 11 and FIG. 12, from a glass substrate, the structure of the metal pad 136 sequentially includes a first metal layer 1361, a first insulating layer 1362, a second metal layer 1363, a passivation layer 1364 and a transparent conductive film layer 1365, where the transparent conductive film layer 1365 is respectively conducted with the first metal layer 1361 and the second metal layer 1363 through a via hole. As shown in FIG. 12, during the preparation, a step a of forming the first metal layer 1361 is first completed, a step b of forming the first insulating layer 1362 on the first metal layer 1361 is completed, a step c of forming the second metal layer 1363 on the first insulating layer 1362 is completed, a step d of forming the passivation layer 1364 on the second metal layer 1363 is then completed, a through hole is made in a blank position at the position of d in the drawing, and finally, a step e of forming the transparent conductive film layer 1365 on the passivation layer 1364 is completed, thereby obtaining the metal pad 136. The schematic structural view of a section B-B′ of the metal pad 136 is as shown in FIG. 13. The fan-out wiring 132 may be connected with the first metal layer 1361, or may be connected with the second metal layer 1363. When the second initiating terminal 1331 of the auxiliary line 133 is connected with the corresponding first initiating terminal 1321 and the second destination terminal 1332 is disconnected from the corresponding first destination terminal 1322, the second initiating terminal 1331 and the first initiating terminal 1321 of the corresponding fan-out wiring 132 may be respectively connected with a first metal line and a second metal line. As another embodiment of this application, as shown in FIG. 13, disclosed is a display panel 110 repair method, where the display panel 110 is the above display panel 110, and the repair method includes:

S131: detecting whether the fan-out wirings 132 work normally;
when the fan-out wirings 132 are normal, performing S132; when the fan-out wirings 132 are open-circuited, performing S133; when the fan-out wirings 132 are short-circuited, performing S134;
where S132: when the fan-out wirings 132 work normally, keeping at least one of the second initiating terminal 1331 and the second destination terminal 1332 of the auxiliary line 133 disconnected from the fan-out wiring 132;

S133: when the fan-out wirings 132 are open-circuited, respectively connecting the second initiating terminal 1331 and the second destination terminal 1332 of the auxiliary line 133 with the first initiating terminal 1321 and the first destination terminal 1322 of the fan-out wiring 132; and

S134: when the fan-out wirings 132 are short-circuited, disconnecting the fan-out wiring 132 corresponding to the opening portion 138 of the auxiliary line 133, and respectively connecting the second initiating terminal 1331 and the second destination terminal 1332 of the auxiliary line 133 with the first initiating terminal 1321 and the first destination terminal 1322 of the fan-out wiring 132.

The fan-out wiring 132 is prone to an open circuit or short circuit due to the manufacture procedure or other reasons. When the fan-out wiring 132 is open-circuited, the two ends of the open-circuited fan-out wiring 132 may be connected with the two ends of the auxiliary line 133, so that the signals originally transmitted through the open-circuited fan-out wiring 132 can be transmitted through the auxiliary line 133; and when the fan-out wiring 132 is short-circuited, the two ends of the short-circuited fan-out wiring 132 may be connected with the two ends of the auxiliary line 133, the fan-out wiring 132 corresponding to the opening portion 138 of the auxiliary line 133 may be disconnected, so that the signals originally transmitted through the short-circuited fan-out wiring 132 can be transmitted through the auxiliary line 133, thereby preventing the display panel 110 from incapability of normally working and being abandoned due to the open circuit or short circuit of the fan-out wiring 132, and increasing the yield of the display panel 110.

In one or more embodiments, the second initiating terminal 1331 and the second destination terminal 1332 of the auxiliary line 133 are respectively connected with the first initiating terminal 1321 and the first destination terminal 1322 of the fan-out wiring 132 through laser melting; the fan-out wiring 132 corresponding to the opening portion 138 of the auxiliary line 133 is disconnected by laser disconnection at the opening portion 138. The second initiating terminal 1331 and the second destination terminal 1332 of the auxiliary line 133 are respectively connected with the first initiating terminal 1321 and the first destination terminal 1322 of the fan-out wiring 132 through laser melting, and the fan-out wiring 132 corresponding to the opening portion 138 is disconnected by laser disconnection, so the operation is simple and feasible. Certainly, the second initiating terminal 1331 and the second destination terminal 1332 of the auxiliary line 133 may also be connected with the first initiating terminal 1321 and the first destination terminal 1322 of the fan-out wiring 132 through a via hole, or another connection and cutting manner.

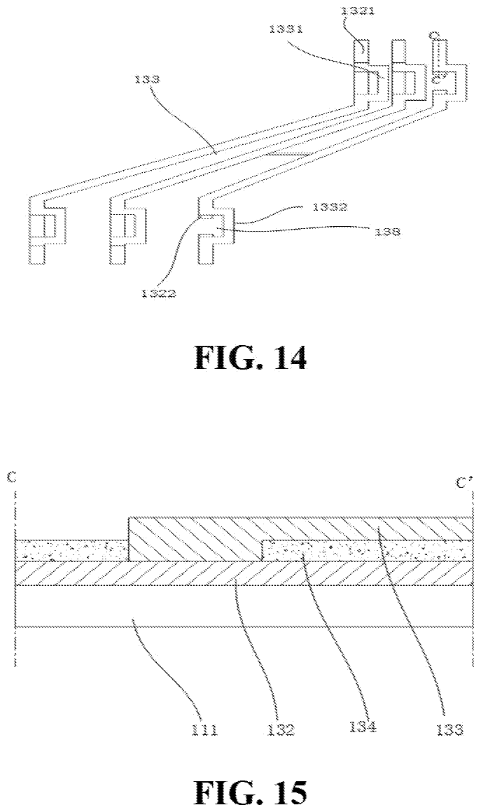

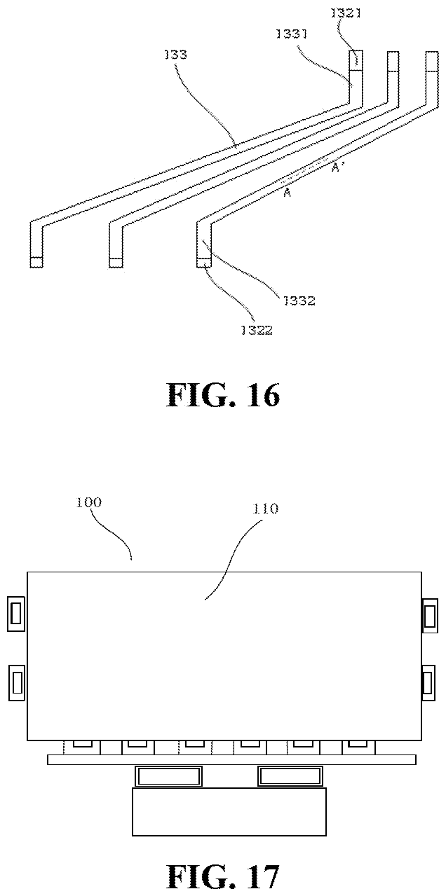

As another embodiment of this application, as shown in FIG. 14 and FIG. 15, disclosed is a display panel 110 formed with an active area 120 and a peripheral area 130, including: a first substrate 111 and a second substrate 112 cell-assembled with the first substrate 111; where the peripheral area 130 includes a fan-out area 131, and the fan-out area 131 is located between an edge of the second substrate 112 and an edge of the active area 120; the first substrate 111 is provided with fan-out wirings 132 for connecting the active area 120 and the peripheral area 130 in the fan-out area 131, the number of the fan-out wirings 132 is multiple, the first substrate 111 is further provided with a plurality of auxiliary lines 133, and the auxiliary lines 133 are arranged in one-to-one correspondence with the fan-out wirings 132; and each of the auxiliary lines 133 includes at least one square opening portion 138 protruding outward, the auxiliary line 133 at the opening portion 138 does not overlap with the corresponding fan-out wiring 132, two ends of at least one of the auxiliary lines 133 are connected with two ends of the corresponding fan-out wiring 132, and the fan-out wiring 132 is in an open-circuited or short-circuited state. When the fan-out wiring 132 is in an open-circuited state, the two ends of the corresponding auxiliary line are both connected with the two ends of the fan-out wiring 132; and when the fan-out wiring 132 is in a short-circuited state, the two ends of the corresponding auxiliary line are both connected with the two ends of the fan-out wiring 132, and the fan-out wiring 132 corresponding to the opening portion 138 is disconnected. Thus, the originally abandoned display panel 110 can be used normally, thereby increasing the yield of the display panel 110.

As another embodiment of this application, with reference to FIG. 17, disclosed is a display device 100, including the above display panel 110.

It should be noted that the sequence numbers of steps involved in a specific solution should not be considered as limiting the order of steps as long as the implementation of this solution is not affected. The steps appearing earlier may be executed earlier than, later than, or at the same time as those appearing later. Such implementations shall all be considered as falling within the protection scope of this application as long as this solution can be implemented.

The technical solutions of this application can be widely applied to various display panels, such as twisted nematic (TN) panels, in-plane switching (IPS) panels, and multi-domain vertical alignment (MVA) panels. Certainly, other suitable types of display panels such as organic light-emitting diode (OLED) display panels are also applicable to the above solutions.

The foregoing contents are detailed descriptions of this application in conjunction with specific optional embodiments, and it should not be considered that the specific implementation of this application is limited to these descriptions. Persons of ordinary skill in the art can further make simple deductions or replacements without departing from the concept of this application, and such deductions or replacements should all be considered as falling within the protection scope of this application.

What is claimed is:

1. A display panel formed with an active area and a peripheral area, comprising:
a first substrate; and
a second substrate, cell-assembled with the first substrate;
wherein the peripheral area comprises a fan-out area, and the fan-out area is located between an edge of the second substrate and an edge of the active area; the first substrate is provided with fan-out wirings for connecting the active area and the peripheral area in the fan-out area, and the number of the fan-out wirings is multiple; and
the first substrate is further provided with a plurality of auxiliary lines, and the auxiliary lines are arranged in one-to-one correspondence with the fan-out wirings; and at least one of the auxiliary lines is disconnected from one end of the corresponding fan-out wiring.

2. The display panel according to claim 1, wherein each of the auxiliary lines comprises at least one opening portion protruding outward, and the auxiliary line at the opening portion does not overlap with the corresponding fan-out wiring.

3. The display panel according to claim 1, wherein the auxiliary line other than the opening portion overlaps with the fan-out wiring, the distance between the auxiliary line at the opening portion and the corresponding fan-out wiring is greater than zero, and the length of the opening portion corresponding to the fan-out wiring direction is greater than zero.

4. The display panel according to claim 3, wherein each of the auxiliary lines comprises two opening portions respectively located at two ends of the auxiliary line.

5. The display panel according to claim 3, wherein each of the auxiliary lines comprises only one opening portion located at one end of the auxiliary line or located at a position away from the two ends of the auxiliary line.

6. The display panel according to claim 3, wherein the peripheral area further comprises a binding area, the binding area is located between an edge of the first substrate and an edge of the second substrate, and the first substrate is provided with a plurality of metal pads in the binding area;
the active area comprises a plurality of pixels;
the fan-out wiring comprises a first initiating terminal and a first destination terminal, the first initiating terminal and the first destination terminal are respectively located at two ends of the fan-out wiring, the first initiating terminal is located at the edge of the second substrate and connected in one-to-one correspondence with the metal pad, and the first destination terminal is located at an edge of the active area and correspondingly connected with the pixel of the active area in a control manner; and
the auxiliary line comprises a second initiating terminal and a second destination terminal, the second initiating terminal and the second destination terminal are respectively located at the two ends of the auxiliary line, the second initiating terminal is adjacent to the edge of the second substrate, the second destination terminal is adjacent to the edge of the active area, and at least one of the second initiating terminal and the metal pad, and the second destination terminal and the first destination terminal of the fan-out wiring are physically disconnected.

7. The display panel according to claim 4, wherein the fan-out wiring is provided with an insulating layer, the auxiliary line is arranged on the insulating layer and the fan-out wiring is not connected with the auxiliary line.

8. The display panel according to claim 4, wherein the fan-out wiring is provided with an insulating layer, the auxiliary line is arranged on the insulating layer, the second initiating terminal of the auxiliary line is connected with the first initiating terminal of the fan-out wiring, and the second destination terminal of the auxiliary line is disconnected from the first destination terminal of the fan-out wiring.

9. The display panel according to claim 4, wherein the fan-out wiring is provided with an insulating layer, the auxiliary line is arranged on the insulating layer, the second initiating terminal of the auxiliary line is disconnected from the first initiating terminal of the fan-out wiring, and the second destination terminal of the auxiliary line is connected with the first destination terminal of the fan-out wiring.

10. The display panel according to claim 1, wherein the fan-out wiring is provided with an insulating layer, the auxiliary line is arranged on the insulating layer, the auxiliary line and the corresponding fan-out wiring have the same shape, and the auxiliary line correspondingly overlaps with the fan-out wiring.

11. The display panel according to claim 1, wherein the line width of the auxiliary line is the same as the line width of the fan-out wiring.

12. The display panel according to claim 1, wherein the thickness of the auxiliary line is the same as the thickness of the fan-out wiring.

13. The display panel according to claim 2, wherein the distance between the auxiliary line at the opening portion and the corresponding fan-out wiring is greater than zero.

14. The display panel according to claim 2, wherein the length of the opening portion along the fan-out wiring direction is greater than the width of the fan-out wiring.

15. A display panel formed with an active area and a peripheral area, comprising:
a first substrate; and
a second substrate, cell-assembled with the first substrate;
wherein the peripheral area comprises a fan-out area, and the fan-out area is located between an edge of the second substrate and an edge of the active area;
the first substrate is provided with fan-out wirings for connecting the active area and the peripheral area in the fan-out area, the number of the fan-out wirings is multiple, the first substrate is further provided with a plurality of auxiliary lines, and the auxiliary lines are arranged in one-to-one correspondence with the fan-out wirings; and
each of the auxiliary lines comprises at least one opening portion protruding outward, the auxiliary line at the opening portion does not overlap with the corresponding fan-out wiring, and two ends of at least one of the auxiliary lines are respectively conducted with the two ends of the corresponding fan-out wiring.

16. A display panel repair method, wherein a display panel comprises:
a first substrate; and
a second substrate, cell-assembled with the first substrate;
wherein a peripheral area comprises a fan-out area, and the fan-out area is located between an edge of the second substrate and an edge of an active area; the first substrate is provided with fan-out wirings for connecting the active area and the peripheral area in the fan-out area, the number of the fan-out wirings is multiple, the first substrate is further provided with a plurality of auxiliary lines, and the auxiliary lines are arranged in one-to-one correspondence with the fan-out wirings; and
each of the auxiliary lines comprises at least one opening portion protruding outward, the auxiliary line at the opening portion does not overlap with the corresponding fan-out wiring, and at least one of the auxiliary lines is disconnected from one end of the corresponding fan-out wiring.
the display panel repair method comprises steps of:
detecting whether the fan-out wirings are normal;
when at least one of the fan-out wirings is open-circuited, respectively connecting a second initiating terminal and a second destination terminal of the auxiliary line with a first initiating terminal and a first destination terminal of the corresponding fan-out wiring; and
when at least two of the fan-out wirings are short-circuited, disconnecting the fan-out wiring corresponding to the opening portion of the auxiliary line, and respectively connecting the second initiating terminal and the second destination terminal of the auxiliary line with the first initiating terminal and the first destination terminal of the fan-out wiring.

17. The display panel repair method according to claim 16, wherein the second initiating terminal of the auxiliary line is connected with the first initiating terminal of the fan-out wiring, and the second destination terminal of the auxiliary line is connected with the first destination terminal of the fan-out wiring through laser melting.

18. The display panel repair method according to claim 16, wherein the fan-out wiring corresponding to the opening portion of the auxiliary line is disconnected by laser disconnection at the opening portion.

19. The display panel repair method according to claim 16, wherein the second initiating terminal of the auxiliary line is connected with the first initiating terminal of the fan-out wiring through a via hole.

20. The display panel repair method according to claim 16, wherein the second destination terminal of the auxiliary line is connected with the first destination terminal of the fan-out wiring through a via hole.
